(19) United States
(12) Patent Application Publication
(10) Pub. No.: US 2025/0074224 A1
(43) Pub. Date: Mar. 6, 2025

(54) SYSTEM FOR PROVIDING AN INTEGRATED POWER RAIL

(71) Applicant: Lear Corporation, Southfield, MI (US)

(72) Inventors: Rafael JIMENEZ PINO, Valls (ES); Ruben MOLINA LLORENTE, REUS (ES); Antonio MARTINEZ PEREZ, Tarragona (ES); Pablo GAONA ROSANES, Sarreal (ES); Oscar LUCIA GIL, Zaragoza (ES); Hector SARNAGO ANDIA, Olvega (ES)

(21) Appl. No.: 18/238,833

(22) Filed: Aug. 28, 2023

(51) Int. Cl. B60L 53/22; B60L 55/00; H02M 7/797

(52) U.S. Cl. CPC B60L 53/22; B60L 55/00; H02M 7/797; B60L 2210/30

(57) ABSTRACT

In at least one embodiment, a system is provided. The system includes a plurality of power phases, a first plurality of switches, a capacitive network, and at least one transformer. The plurality of power phases receives an alternating current input signal having a plurality of phases from a mains supply, each power phase including a pair of switches and receiving a corresponding phase of the AC input signal to generate a first voltage signal. The first plurality of switches generates a second voltage signal based at least on a capacitive voltage and the first voltage signal. The capacitive network provides the capacitance voltage to the first plurality of switches. The at least one transformer includes a center tap and provides a third voltage to a second plurality of switches based at least on the second voltage. The center tap is coupled to the mains supply through a neutral line input.

### TECHNICAL FIELD

Aspects disclosed herein system and method for providing an integrated power rail. These aspects and other will be discussed in more detail.

### BRIEF DESCRIPTION OF THE DRAWINGS

FIG. 1 depicts one example of a system for transferring energy between a high voltage node and a lower voltage node; and

FIG. 2 depicts a system for providing an integrated power rail in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The disclosed system provides a power conversion device. In one example, the power conversion device is an on-board charger (OBC) that includes a direct current (DC)/DC converter. The DC/DC converter is, for example, a dual active bride (DAB) based DC/DC converter. The DC/DC converter converts a DC input voltage into a DC output voltage. In one operational mode, the DC/DC converter is a boost DC/DC converter that converts a DC input voltage with a DC input current into a higher DC output voltage with a lower DC output current. Conversely, in another operational mode, the DC/DC converter is a buck DC/DC converter converts a DC input voltage with a DC input current into a lower DC output voltage with a higher DC output current.

Generally, the DC/DC converter includes a set of input power switches, a transformer, and a set of output power switches. The input power switches are controlled to invert the DC input voltage into an alternating current (AC) input voltage. A transformer transforms the AC input voltage into an AC output voltage having a different voltage level. The output power switches are controlled to rectify the AC output voltage into the DC output voltage.

A vehicle may have a high-voltage (HV) network and a low-voltage (LV) network. In this case, a DC/DC converter may be used to connect the HV and LV networks together. Consequently, a high DC input voltage of the HV network may be converted by the DC/DC converter into a low DC output voltage for use by loads connected to the LV network. Conversely, assuming the DC/DC converter is bidirectional, a low DC input voltage of the LV network may be converted by the DC/DC converter into a high DC output voltage for use by loads connected to the HV network.

Single stage OBCs include an integrated transformer-secondary-side stage for size and cost optimization. However, the need to accept multiple phase AC inputs may require consideration of multiple transformer primary-side rails. This has also led to the implementation of a pulsating buffer converter that is positioned at an end of a secondary side of the OBC to minimize an output ripple from the output of the OBC. Aspects disclosed herein generally provide a single power device that enables a full energy transfer process from a neutral connection from an alternating current (AC) power supply (or AC mains (orange box) while each AC-phase line port is provided in a minimized design stage and is conditioned to assure a correct power factor (in a blue box). The disclosed system also provides power scalability (e.g., 11/22 kW) may be achieved by various components of AC lines (e.g., resistor Rdson) and magnetic parameters in addition to paralleling a power conversion stage (e.g., that may be initially designed for 11 kW-power processing). The disclosed system, for example, reduces weight and size of the OBC due to, among other things, less components and is an enabler for an improved and inexpensive mechanical design with improved efficiency. The disclosed system is, for example, scalable from 400V to 800V and from, for example, 11 kW to 22 kW.

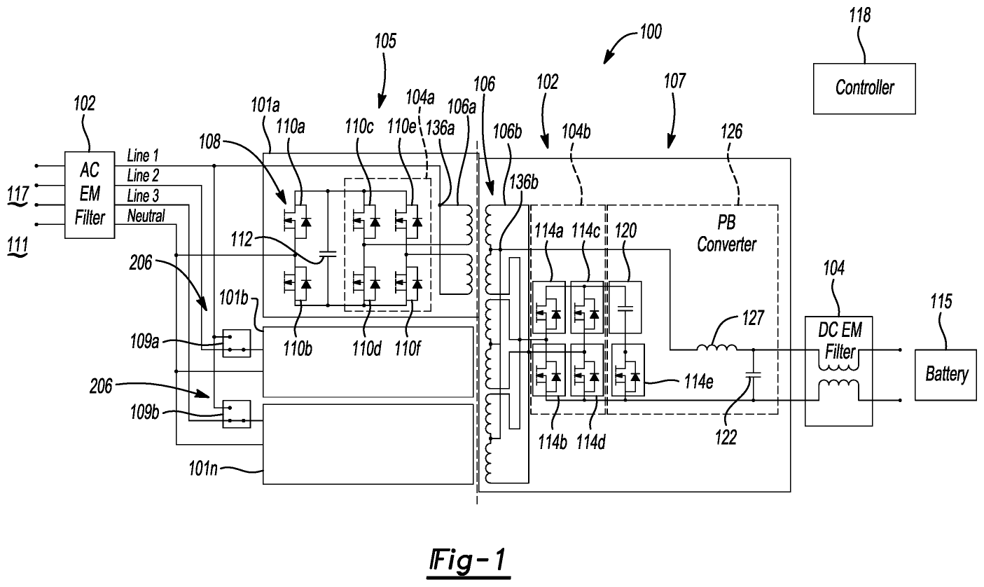

FIG. 1 depicts one example of a system 100 for transferring energy in a vehicle. In one example, the system 100 may be implemented as an On-board Charger (OBC) and include a DC/DC converter. The system 100 generally includes a plurality of modular converters 101a-101n (or “101”) and a pulsating buffer (PB) converter 126. Each corresponding modular converter 101 includes a rectifying half bridge structure 108 and the DAB stages 104a, 104b. Each of the modular converters 101 also includes one transformer 106 (e.g., a single transformer 106 with two primary windings 106a (or primary-side transformer 106a) positioned on a primary side 105 and two or more secondary windings (or secondary-side transformer 106b) positioned on the secondary side 107, and the PB converter 126. A plurality of selector switches 109a-109b is coupled to a first filter 102 for selectively providing phases (e.g., LINE 1, LINE 2, LINE 3) and a neutral line input to a corresponding modular converter 101. A main supply (or AC mains) 117 provides an AC input at the plurality of phases to the system 100. The controller 218 is configured to control the plurality of selectors switches 109a-109b to select the corresponding phase to provide an input to a modular converter 101.

In general, there is one transformer 106 per modular converter 101 and each transformer 106 includes a primary with two coils or windings 106a (with a middle point (or center tap) 136a) (or the two primary windings 106a) and a secondary with two coils or windings 106b (with a middle point (or a center tap 136b) (or the two secondary windings 106b). While FIG. 1 illustrates additional modular converters 101b-101n, it is recognized that each of these modular converters 101b-101n include similar features to that depicted as shown in the modular converter 101a. It is recognized that the primary windings 106a is only illustrated for the modular converter 101a and is not illustrated for the remaining modular converters 101b-101n. Similarly, it is recognized that the secondary windings 106b is illustrated in FIG. 1 for all modular converters 101a-101n.

The apparatus 100 includes the first filter 102 and a second filter 134. The first filter 102 is operably coupled to a primary side 105 of each converter 101. The second filter 134 is operably coupled to a secondary side 107 that is common to all converters 101. The first filter 102, is for example, an AC electromagnetic interference (EMI) filter used to comply with EMC (electromagnetic compatibility) standards. The second filter 134 may be a DC EMI filter used to ensure smooth output current supplied to a battery 115. The second filter 134 may be implemented in a number of OBC designs for the automotive market. It is recognized the number of modular converters 101 implemented in the disclosed apparatus 101 will vary based on the desired criteria of a particular implementation.

Each of the converters 101 includes a plurality of switches 110a-110f (“210”) and a capacitor 112. The switches 110a-110b generally form a rectifier 108. The rectifier 108 is generally coupled to the mains supply 106 to rectify an incoming AC input. The plurality of switches 110 and the capacitor 112 are operably coupled to the primary-side transformer 106a for each the modular converters 101. In operation, the rectifier 108, which includes the switches 110a and 110b, provides a rectified output voltage or current in response to an output provided by the first filter 102. The rectifier 108 provides the rectified output voltage to the primary side 105. One or more controllers 118 (hereafter “the controller 118”) controls the switches 110 to provide a requisite amount of rectified output current associated from the rectified output voltage from the rectifier 108 to generate a primary-side output voltage or current on the primary-side transformer 106a.

The switches 110c-110f (or the first active bridge) on the primary side 105 receive the rectified output voltage/current from the rectifier 108. The controller 118 controls the operation of the primary-side power switch bridge (or the switches 110c-110f) to draw a requisite amount of rectified output current associated with the rectified output voltage from the rectifier 108 and generate therefrom a primary-side output voltage on primary-side transformer 106a. The controller 118 controls the switches 114a-114d to generate a secondary-side input voltage/current on the secondary-side 107 (or on the secondary-side transformer 106b).

The DAB stage 104b includes power switches 114a-114d (or the second active bridge) that are positioned on the secondary side 107. The PB converter 126 includes a switch 114e, capacitors 120 and 122, and an inductor 127. Capacitor 122 is a bus capacitor that is used to decouple electrical devices on the PB converter 126. The PB converter 126 may provide for energy transfer based on magnetic energy stored on the inductor 127 and electrical energy stored on the capacitor 122. This aspect may be controlled based on the manner in which the controller 118 controls the switches. The capacitor 120 is charged with the secondary side input voltage or current which supplements the main energy flow that flows from the primary side 105 to the secondary side 107, or from the secondary side 107 to the primary side 105. The capacitor 120 supplements the main energy flow to reduce or minimize the ripple of the output that is stored on the battery 115. The secondary side 107 provides the primary voltage output that is stored on the battery 115, while the PB converter 126 reduces the ripple associated with the voltage output. The PB converter 126 draws a buffer current associated with a buffer voltage from the capacitor 120 which is provided to the battery 115 via the second filter 134. The controller 118 controls the operation of the power switches 114a-114d. As noted above, the power switches 114a-114d are on the secondary side 107 and the switch 114e along with the capacitor 120. Thus, in this regard, a portion of the PB converter 126 (e.g., the switch 114e and the capacitor 120) is combined together with the switches 114a-114d (or the DAB stage 104b) on the secondary side 107. The PB converter 126 draws a requisite amount of buffer current associated with the buffer voltage and generates therefrom a targeted, battery voltage/current. The PB converter 126 generates the required current to eliminate a current ripple that may have a frequency of, for example, 100 to 120 Hz and provides a smooth DC current to the battery 115. In one example, the PB converter 126 minimizes the current ripple on the energy provided by the secondary-side transformer 106b and the DAB stage 104b to deliver a targeted battery voltage/current to charge the battery 115. As noted above, the PB converter 126 is combined with the secondary side 107 (e.g., the switches 114a-114d). The controller 118 employs a control strategy (and control blocks) which enables the control of the PB converter 126 to be integrated with control of the secondary side 107. One example of a control strategy is set forth in pending U.S. application Ser. No. 17/335,661 (“the '661 application”) entitled “APPARATUS FOR SINGLE STAGE ON-BOARD CHARGER WITH AN INTEGRATED PULSATING BUFFER CONTROL” as filed on Jun. 1, 2021, which is hereby incorporated by reference in its entirety. It is recognized the secondary side 107 includes the DAB stages 104b, the transformer secondary 106b, and the PB converter 126.

The apparatus 100 is used, for example, in connection with a 22 kW, 400V variant assuming that various values for the electrical devices illustrated on the apparatus 200 are utilized. In this regard, the battery 115 is coupled to center point 136b of the secondary-side transformer 106b via the inductor 127 and the capacitor 120 is coupled to a secondary bus (e.g., to the switches 114) which is capable of being charged to at or around, for example, 400V.

It is recognized that the OBC 100 is bi-directional and in one direction (or when the OBC 100 is discharging energy or is in a discharging state), the OBC 100 enables the battery 115 to provide a voltage to the secondary side 107 and energy is delivered back through the primary side 105 to provide an AC output on an electrical grid 111. In the other direction (or when the OBC 100 is in a charging stage (e.g., AC DC conversion to store DC energy on battery 115)), the OBC 100 provides AC energy from the mains supply 106 to the primary side 105 where an AC output is provided therefrom to the secondary side 107 (and the PB converter 126) to generate a DC output for storage on the battery 115.

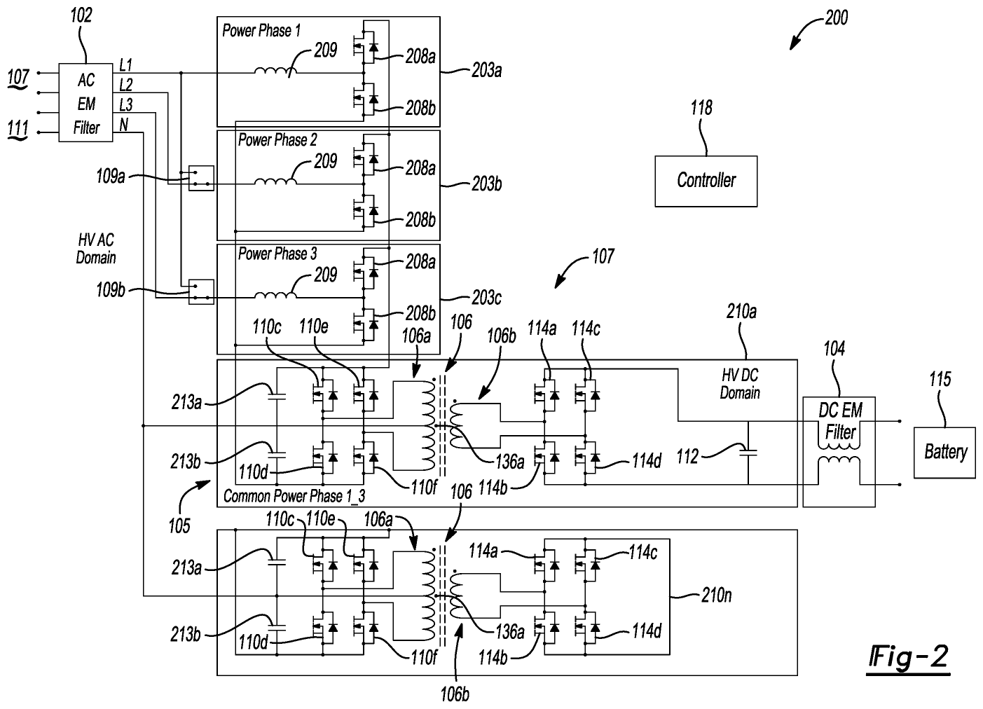

FIG. 2 depicts a system (or OBC) 200 for providing an integrated power rail in accordance with one embodiment. The system 200 includes plurality of power phases 203a-203c and a common power phase 210a. The plurality of selector switches 109a-109b is coupled to a first filter 102 for selectively providing the phases (e.g., LINE 1, LINE 2, LINE 3) to a corresponding power phase 203a, 203b, 203c. The neutral line input from the AC mains 117 is provided to the common power phase 210a. The AC input provided by the AC mains 117 includes the phases (e.g., LINE 1, LINE 2, LINE 3) used in electricity generation, transmission, and distribution. Three lines (or wires) are provided to transmit the corresponding phases (e.g., LINE 1, LINE 2, LINE 3), respectively, and an additional wire that provides the neutral line input which serves as a return wire to a ground or busbar. Each phase provided by the AC mains 117 is generally separated by 120 electrical degrees apart. The controller 218 is configured to control the plurality of selectors switches 109a-109b to select the corresponding phase to provide an input to a modular converter 101. As shown, the neutral line input is directly coupled to the center tap 136 positioned on the primary side 105. The relevance of this aspect will be discussed in more detail below.

Each of the power phases 203a-203c includes a plurality of switches 208a-208b and an inductor 209. The plurality of switches 208a-208c for each power phase 203a-203c generally form a rectifier to rectify the AC input being provided on the various phase (e.g., LINE 1, LINE 2, LINE 3). In operation, power phases 203a-203c, which includes the switches 110a and 110b, provide a rectified output voltage or current in response to AC output provided by the first filter 102. Each of the power phases 203a-203c generally operate as boost rectifiers. In addition, each of the power phases 203a-203c includes an inductor 209 (or boost inductor 209). The boost inductors 209 boost a bus voltage (e.g., voltage across capacitors 213a and 213b).

The common power phase 210a includes a capacitive bank 213 having capacitors 213a and 213b. The plurality of switches 110c-110f and the capacitor 112 are operably coupled to the primary-side transformer 106a. It is recognized that any one or more power phases 210 can be added to the system 200 to increase the power scalability (e.g., 11/22KW). The controller 118 controls the switches 110c-110f to provide a requisite amount of rectified output current associated from the rectified output voltage from the rectifier 108 to generate a primary-side output voltage or current on the primary-side transformer 106a.

The switches 110c-110f (or the first active bridge) on the primary side 105 receive the rectified output voltage/current from the rectifier 108. The controller 118 controls the operation of the primary-side power switch bridge (or the switches 110c-110f) to draw a requisite amount of rectified output current associated with the rectified output voltage from the rectifier 108 and generate therefrom a primary-side output voltage on primary-side transformer 106a. The controller 118 controls the switches 114a-114d to generate a secondary-side input voltage/current on the secondary-side 107 (or on the secondary-side transformer 106b). Thus, in this regard, the switches 114a-114d provide a voltage that is stored on at least the capacitor 122 and/or the battery 104 after such energy is filtered by the second filter 134. The system 200 illustrates provides an energy conversion device that does not need the implementation of a PB converted as noted in the system 100 of FIG. 1. For example, the system 100 of FIG. 1 is, for example, implemented to buffer current on the secondary side 107 since the single stage topology of FIG. 1 does not include a DC-link.

By directly coupling the neutral line input (N) directly to the center tap 136a of the transformer 106 on the primary side 105, (i) it is possible to reduce the overall capacitance for the capacitors 213a and 213b, and (ii) reduce the overall number of switches positioned in the power phases 203a-203 for the system 200 in view of conventional implementations. An overall reduction in the capacitance for the capacitors 213a and 213b may be achieved since the coupling of the neutral line input (N) directly to the center tap 136a of the transformer 106 on the primary side 105a allows the voltage to increase by a predetermined amount (e.g., the voltage is doubled). As a consequence of this voltage increase, a high voltage ripple operation in the capacitors 213a and 213b is allowed, thereby maximizing the use of the energy stored in the capacitor and, consequently, reducing the required capacitor size, i.e., capacitance.

In general, the capacitive bank 213, the switches 110c-110f, the transformer 136, the switches 114a-114d form a DC/DC converter 250. The DC/DC converter 250 operates in a buck mode when transferring energy from the AC mains 117 to the battery 115. For example, in a vehicle charging mode (i.e., the DC/DC converter 250 operates as a buck converter), the AC mains 117 provides the AC input signal to the switches 208a-208b with rectify the AC input signal to generate a rectified voltage signal (e.g., first voltage signal). The first voltage signal is a high voltage signal and the controller 150 selectively activates/deactivates one or more of the first plurality of switches 110c-110f to generate at second voltage signal at least based on the first voltage signal and a capacitive voltage provided by the capacitive bank 213 (or capacitive network 213). The transformer 106 provides a third voltage signal to the switches 114a-114d in response to the second voltage signal. The switches 114a-114d generate a fourth voltage signal in response to the third voltage signal for storage on the battery 115. The switches 114a-114d The filter 134 filters the fourth voltage signal prior to being stored on the battery 115. The transformer 106 transforms the AC input into a stepped down AC output signal. The controller 150 selectively activates/deactivates one or more of the second plurality of switches 250a-250d to rectify the stepped down AC output signal into a DC output signal for storage on the one or more of the batteries 104. In this example, the first voltage signal includes a voltage that is greater than the voltage of the fourth voltage signal.

In a vehicle discharging mode (or the DC/DC converter 250 operates as a boost converter), the batteries 115 provide a low voltage DC signal (e.g., the fourth voltage signal) to the second plurality of switches 114a-114d. The controller 118 selectively activates/deactivates the switches 114a-114d to generate a DC based pulse width modulated (PWM) signal that is provided to the transformer 136. The transformer 140 steps up the DC based PWM signal to provide a stepped-up DC based PWM signal. The controller 150 selectively activates/deactivates the 110c-110f to further increase the stepped-up DC based PWM signal into the high voltage output signal (or VHV). The switches 208a-208b may invert the output of the switches 208a-208b to generate an AC output signal that is provided to the grid 111.

Clause 1. In some embodiments, a system includes a plurality of power phases receiving an alternating current input signal having a plurality of phases from a mains supply, each power phase including a pair of switches and receiving a corresponding phase of the AC input signal to generate a first voltage signal; a first plurality of switches generating a second voltage signal based at least on a capacitive voltage and the first voltage signal; a capacitive network being coupled to the first plurality of switches, the capacitive network providing the capacitance voltage to the first plurality of switches based on at least the first voltage signal, and at least one transformer including a center tap and providing a third voltage to a second plurality of switches based at least on the second voltage, wherein the center tap is coupled to the mains supply through a neutral line input to reduce a capacitance of the capacitive network.

Clause 2. According to the system of clause 1, the center tap of the at least one transformer directly receives the neutral line input which increases the capacitive voltage by a predetermined amount causing the reduction in the capacitance of the capacitive network.

Clause 3. According to the system of clause 1, wherein center tap is positioned on a primary side of the at least one transformer.

Clause 4. According to the system of clause 1, the neutral line input is only connected to the capacitive network and to the center tap of the at least one transformer to reduce the number of switches positioned in the plurality of power phases.

Clause 5. According to the system of clause 1, the second plurality of switches is coupled to a secondary side of the at least one transformer, the second plurality of switches generating a fourth voltage signal in response to the third voltage signal and storing the fourth voltage signal on one or more batteries in a vehicle.

Clause 6. According to the system of clause 5, further including a first filter filtering the fourth voltage signal prior to the fourth voltage signal being stored on the one or more batteries.

Clause 7. According to the system of clause 6, the first voltage signal is greater than the fourth voltage signal.

Clause 8. In some embodiments, a system including a plurality of power phases receiving an alternating current (AC) input signal having a plurality of phases from a mains supply, each power phase of the plurality of phases including a plurality of switches and receiving a corresponding phase of the AC input signal to generate a first voltage signal; a first plurality of switches generating a second voltage signal based at least on a capacitive voltage and the first voltage signal; a capacitive network being coupled to the first plurality of switches, the capacitive network providing the capacitance voltage to the first plurality of switches based on at least the first voltage signal, and at least one transformer including a center tap and providing a third voltage to a second plurality of switches based at least on the second voltage, wherein the center tap is coupled to the mains supply through a neutral line input to increase the capacitive voltage provided by the capacitive network.

Clause 9. According to the system of clause 8, the center tap of the at least one transformer directly receives the neutral line input which increases the capacitive voltage by a predetermined amount causing a reduction in a capacitance of the capacitive network.

Clause 10. According to the system of clause 9, the center tap is coupled to the mains supply through the neutral line input to reduce a capacitance of the capacitive network.

Clause 11. According to the system of clause 8, the center tap is positioned on a primary side of the at least one transformer.

Clause 12. According to the system of clause 8, the neutral line input is only connected to the capacitive network and to the center tap of the at least one transformer to reduce the number of switches positioned in the plurality of power phases.

Clause 13. According to the system of clause 8, the second plurality of switches is coupled to a secondary side of the at least one transformer, the second plurality of switches generating a fourth voltage signal in response to the third voltage signal and storing the fourth voltage signal on one or more batteries in a vehicle.

Clause 14. According to the system of clause 13, further including a first filter filtering the fourth voltage signal prior to the fourth voltage signal being stored on the one or more batteries.

Clause 15. According to the system of clause 14, the first voltage signal is greater than the fourth voltage signal.

Clause 16. In some embodiments, a system including a plurality of power phases receiving an alternating current (AC) input signal having a plurality of phases from a mains supply, each power phase of the plurality of phases including a plurality of switches and receiving a corresponding phase of the AC input signal to generate a first voltage signal; a first plurality of switches generating a second voltage signal based at least on a capacitive voltage and the first voltage signal; a capacitive network being coupled to the first plurality of switches, the capacitive network providing the capacitance voltage to the first bridge circuit based on at least the first voltage signal, and at least one transformer including a center tap and providing an output voltage to store one or more batteries in a vehicle based at least on the second voltage, wherein the center tap is coupled to the mains supply through a neutral line input to increase the capacitive voltage provided by the capacitive network.

Clause 17. According to the system of clause 16, the center tap of the at least one transformer directly receives the neutral line input which increases the capacitive voltage by a predetermined amount causing a reduction in a capacitance of the capacitive network.

Clause 18. According to the system of clause 16, the center tap is coupled to the mains supply through the neutral line input to reduce a capacitance of the capacitive network.

Clause 19. According to the system of clause 16, the center tap is positioned on a primary side of the at least one transformer.

Clause 20. According to the system of clause 16, the neutral line input is only connected to the capacitive network and to the center tap of the at least one transformer to reduce the number of switches positioned in the plurality of power phases.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a plurality of power phases receiving an alternating current input signal having a plurality of phases from a mains supply, each power phase including a pair of switches and receiving a corresponding phase of the AC input signal to generate a first voltage signal;
a first plurality of switches generating a second voltage signal based at least on a capacitive voltage and the first voltage signal;
a capacitive network being coupled to the first plurality of switches, the capacitive network providing the capacitance voltage to the first plurality of switches \ based on at least the first voltage signal, and
at least one transformer including a center tap and providing a third voltage signal to a second plurality of switches based at least on the second voltage signal, wherein the center tap is coupled to the mains supply through a neutral line input to reduce a capacitance of the capacitive network.

2. The system of claim 1, wherein the center tap of the at least one transformer directly receives the neutral line input which increases the capacitive voltage by a predetermined amount causing the reduction in the capacitance of the capacitive network.

3. The system of claim 1, wherein the center tap is positioned on a primary side of the at least one transformer.

4. The system of claim 1, wherein the neutral line input is only connected to the capacitive network and to the center tap of the at least one transformer to reduce a number of switches positioned in the plurality of power phases.

5. The system of claim 1, wherein the second plurality of switches is coupled to a secondary side of the at least one transformer, the second plurality of switches generating a fourth voltage signal in response to the third voltage signal and storing the fourth voltage signal on one or more batteries in a vehicle.

6. The system of claim 5 further comprising a first filter filtering the fourth voltage signal prior to the fourth voltage signal being stored on the one or more batteries.

7. The system of claim 6, wherein the first voltage signal is greater than the fourth voltage signal.

8. A system comprising:
a plurality of power phases receiving an alternating current (AC) input signal having a plurality of phases from a mains supply, each power phase of the plurality of phases including a plurality of switches and receiving a corresponding phase of the AC input signal to generate a first voltage signal;
a first plurality of switches generating a second voltage signal based at least on a capacitive voltage and the first voltage signal;
a capacitive network being coupled to the first plurality of switches, the capacitive network providing the capacitance voltage to the first plurality of switches based on at least the first voltage signal, and
at least one transformer including a center tap and providing a third voltage to a second plurality of switches based at least on the second voltage signal, wherein the center tap is coupled to the mains supply through a neutral line input to increase the capacitive voltage provided by the capacitive network.

9. The system of claim 8, wherein the center tap of the at least one transformer directly receives the neutral line input which increases the capacitive voltage by a predetermined amount causing a reduction in a capacitance of the capacitive network.

10. The system of claim 8, wherein the center tap is coupled to the mains supply through the neutral line input to reduce a capacitance of the capacitive network.

11. The system of claim 8, wherein the center tap is positioned on a primary side of the at least one transformer.

12. The system of claim 8, wherein the neutral line input is only connected to the capacitive network and to the center tap of the at least one transformer to reduce a number of switches positioned in the plurality of power phases.

13. The system of claim 8, wherein the second plurality of switches is coupled to a secondary side of the at least one transformer, the second plurality of switches generating a fourth voltage signal in response to the third voltage signal and storing the fourth voltage signal on one or more batteries in a vehicle.

14. The system of claim 13—further comprising a first filter filtering the fourth voltage signal prior to the fourth voltage signal being stored on the one or more batteries.

15. The system of claim 14, wherein the first voltage signal is greater than the fourth voltage signal.

16. A system comprising:
a plurality of power phases receiving an alternating current (AC) input signal having a plurality of phases from a mains supply, each power phase of the plurality of phases including a plurality of switches and receiving a corresponding phase of the AC input signal to generate a first voltage signal;
a first plurality of switches generating a second voltage signal based at least on a capacitive voltage and the first voltage signal;
a capacitive network being coupled to the first plurality of switches, the capacitive network providing the capacitance voltage to the first plurality of switches based on at least the first voltage signal; and
at least one transformer including a center tap and providing an output voltage to store one or more batteries in a vehicle based at least on the second voltage, wherein the center tap is coupled to the mains supply through a neutral line input to increase the capacitive voltage provided by the capacitive network.

17. The system of claim 16, wherein the center tap of the at least one transformer directly receives the neutral line input which increases the capacitive voltage by a predetermined amount causing a reduction in a capacitance of the capacitive network.

18. The system of claim 16, wherein the center tap is coupled to the mains supply through the neutral line input to reduce a capacitance of the capacitive network.

19. The system of claim 16, wherein the center tap is positioned on a primary side of the at least one transformer.

20. The system of claim 16, wherein the neutral line input is only connected to the capacitive network and to the center tap of the at least one transformer to reduce a number of switches positioned in the plurality of power phases.
